(19) United States
(12) Patent Application Publication
(10) Pub. No.: US 2026/0243130 A1
(43) Pub. Date: Aug. 20, 2026

(54) SAFETY GATE

(71) Applicant: Beth Morris, Louisville, TN (US)

(72) Inventor: Beth Morris, Louisville, TN (US)

(21) Appl. No.: 19/540,987

(22) Filed: Feb. 16, 2026

Related U.S. Application Data
(60) Provisional application No. 63/759,374, filed on Feb. 17, 2025.

(51) Int. Cl. E06B 9/06; E05B 65/00; E06B 9/00; E06B 9/02; E06B 9/04; E06B 9/08; E06B 11/02

(52) U.S. Cl. CPC E06B 9/04; E05B 65/0014; E06B 9/01; E06B 9/02; E06B 9/06; E06B 9/0607; E06B 9/0623; E06B 9/0692; E06B 9/08; E06B 11/02; E06B 2009/002; E06B 2009/015

(57) ABSTRACT

Various implementations include a modular safety gate comprising a first side section, a second side section, and a gate door positioned between the first side section and the second side section. The modular safety gate includes a locking mechanism attached to the gate door. The locking mechanism comprises a grip attached to a vertical locking spindle and at least one pin extending from the grip. The at least one pin is configured to engage with corresponding cut-out portions in the first side section and the gate door to secure the gate door in a closed position.

### BACKGROUND

Child and pet safety gates are widely used in homes to restrict access to certain areas, such as stairways or rooms containing potential hazards. These gates provide an important barrier to help prevent accidents and injuries, especially for young children and pets who may not understand potential dangers.

Traditional safety gates often come in fixed sizes that may not fit perfectly in all doorways or openings. This can lead to improper installation or gaps that reduce the effectiveness of the gate. Additionally, many existing gates require permanent mounting to door frames or walls, which can damage surfaces and make the gates difficult to remove or relocate as needed.

The operation of safety gates can also present challenges for users. Some gates have complicated locking mechanisms that are difficult to engage and disengage, especially when carrying a child or managing a pet. Gates that are too easy to open, however, may be defeated by clever children or persistent pets. Finding the right balance of security and usability is an ongoing challenge in safety gate design.

Portability and storage are other important considerations. Bulky, rigid gates can be cumbersome to move between locations or store when not in use. This lack of flexibility limits the utility of the gate for families with changing needs or those who want to use a gate in multiple areas of the home.

As home layouts and family needs continue to evolve, there is an ongoing need for improved safety gate designs that offer greater versatility, ease of use, and effectiveness in a variety of settings. Addressing the limitations of existing gates could enhance child and pet safety while providing more convenience for caregivers.

### SUMMARY

Various implementations include a modular safety gate. The modular safety gate includes a first side section, a second side section, and a gate door positioned between the first side section and the second side section. The modular safety gate includes a locking mechanism attached to the gate door. The locking mechanism includes a grip attached to a vertical locking spindle and at least one pin extending from the grip. The at least one pin is configured to engage with corresponding cut-out portions in the first side section and the gate door to secure the gate door in a closed position.

In some implementations, the cut-out portions include tapered grooves in the first side section and the gate door.

In some implementations, the locking mechanism includes two pins extending from the grip. In some implementations, the two pins are aligned with each other but axially spaced apart. In some implementations, the locking mechanism includes four pins total, with two pairs of aligned but axially spaced apart pins. In some implementations, the at least one pin includes a single pin passing entirely through the grip.

In some implementations, the locking mechanism further includes a swivel lock pivotably coupled to the first side section and configured to engage with the grip when the gate door is in the closed position.

In some implementations, the modular safety gate further includes a redundant locking mechanism including a strap attached to the gate door and configured to wrap around the grip when the gate door is in the closed position. In some implementations, the modular safety gate further includes a redundant locking mechanism including a slide latch mounted on the first side section and configured to engage with the gate door when in the closed position. In some implementations, the modular safety gate further includes a redundant locking mechanism including a swivel cover attached to the gate door and configured to cover the grip when the gate door is in the closed position.

In some implementations, the modular safety gate further includes a saddle cover fastened to the grip, wherein the saddle cover is configured to lift and slide with the grip to open the gate door. In some implementations, the saddle cover includes a spring pin mechanism for securing the saddle cover in a closed position. In some implementations, the grip includes a T-handle attached to the saddle cover and connected to the vertical locking spindle.

In some implementations, the modular safety gate further includes a spindle encasement piece attached to an underside of a rail of the first side section, the spindle encasement piece extending outwardly from the rail on each side to serve as a downward limiter for at least one side arm. In some implementations, the spindle encasement piece extends from the rail by one to two inches on each side.

In some implementations, a bottom rail of the first side section includes a lower cutout and an upper cutout, the lower cutout being wider and lower in height than the upper cutout, and the upper cutout being offset to one side to prevent the vertical locking spindle from being pulled out while allowing the vertical locking spindle to slide horizontally to open the gate door.

In some implementations, the modular safety gate further includes a single spindle expansion unit configured to extend a width of the gate door, the single spindle expansion unit including insert slots for bolts or barrel screws.

In some implementations, a top rail and a bottom rail each include holes configured to allow vertical spindles to pass through and attach to the rails to stabilize the gate door and prevent sagging.

Various other implementations include a modular safety gate. The modular safety gate includes a first side section, a second side section, and a gate door positioned between the first side section and the second side section. The modular safety gate includes at least one side arm attached to at least one of the first side section or the second side section. The at least one side arm includes a grip attached to the respective side section and at least two approximately parallel tines extending away from the respective side section. The tines are configured to squeeze a building structure therebetween.

In some implementations, the grip includes a sliding mechanism configured to retract and extend the tines. In some implementations, the sliding mechanism includes a pin that engages with a track in the respective side section.

In some implementations, the tines are flexible and include non-marring surfaces. In some implementations, the tines are spring-loaded to allow separation when fitting around a building structure.

In some implementations, the at least one side arm is offset from the respective side section to allow placement of the gate slightly forward in a doorway. In some implementations, the at least one side arm includes a ring collar clamp with a spring-loaded opening mechanism. In some implementations, the at least one side arm includes a ball and joint connection to the respective side section, allowing flexible positioning of the side arm.

In some implementations, the modular safety gate further includes a U-shaped bar with outward extensions affixed to the tines to prevent downward drift of the side arm. In some implementations, the U-shaped bar is placed over an outer end of the grip.

In some implementations, the at least one side arm further includes a stretchy cord, strap, or expansion spring encased in nested tubes and attached to a lower side portion of the tines. In some implementations, the stretchy cord, strap, or expansion spring is attached to the tines via screw hooks with hooks facing inward.

In some implementations, the grip includes finger indents on a grip surface. In some implementations, the at least one side arm includes a tube or barrel screw component. In some implementations, the respective side section includes a cutout recessed portion configured to allow expansion of the at least one side arm.

In some implementations, the modular safety gate further includes hooks screwed into lower portions of the tines, the hooks configured to be placed at finger openings to allow easy opening of the at least one side arm.

In some implementations, the modular safety gate further includes a spindle encasement piece attached to an underside of a rail of the respective side section, the spindle encasement piece extending outwardly from the rail to serve as a downward limiter for the at least one side arm. In some implementations, the spindle encasement piece extends from the rail by one to two inches on each side.

In some implementations, the tines are configured to retract into the respective side section via a cutout recessed portion when not in use.

### BRIEF DESCRIPTION OF DRAWINGS

Example features and implementations of the present disclosure are disclosed in the accompanying drawings. However, the present disclosure is not limited to the precise arrangements and instrumentalities shown. Similar elements in different implementations are designated using the same reference numerals.

FIG. 1A is a front view of a modular child/pet gate with locking mechanism details, according to one implementation.

FIG. 1B is a top view of a locking mechanism, according to one implementation.

FIG. 1C is a top view of a locking mechanism, according to another implementation.

FIG. 1D is a side view of the locking mechanism of FIG. 1A.

FIG. 1E is a side view of the locking mechanism of FIG. 1B.

FIG. 2A is a side view of a locking mechanism, according to another implementation.

FIG. 2B is a side view of a locking mechanism, according to another implementation.

FIG. 2C is a side view of a locking mechanism, according to another implementation.

FIG. 2D is a side view of a strap of a locking mechanism, according to another implementation.

FIG. 2E is a side view of a locking mechanism, according to another implementation.

FIG. 2F is a side view of a locking mechanism, according to another implementation.

FIG. 3A is a side view of a cover of a locking mechanism, according to another implementation.

FIG. 3B is a side view of a T-handle of a locking mechanism, according to another implementation.

FIG. 3C is a top view of a locking mechanism, according to another implementation.

FIG. 3D is a top view of a locking mechanism, according to another implementation.

FIG. 4A is a side view of the side arm mechanisms shown in FIG. 2A.

FIG. 4B is an exploded detail side view of the side arm mechanism shown in FIG. 4A.

FIG. 4C is a side view of a side arm mechanism, according to another implementation.

FIG. 5A is a top view of the side arm mechanism shown in FIG. 1A.

FIG. 5B is a top view of a side arm mechanism, according to another implementation.

FIG. 5C is a top view of a side arm mechanism, according to another implementation.

FIG. 5D is a top view of a side arm mechanism, according to another implementation.

FIG. 5E is a top view of a side arm mechanism, according to another implementation.

FIG. 5F is a top view of a side arm mechanism, according to another implementation.

FIG. 5G is a top view of a side arm mechanism, according to another implementation.

FIG. 6 is a side view of a modular child/pet gate with locking mechanism details, according to another implementation.

FIG. 7 is a side view of a modular child/pet gate with locking mechanism details, according to another implementation.

FIG. 8A is a side view of a tubular telescoping or nested pipe rail system, according to one implementation.

FIG. 8B is a top view of the tubular telescoping or nested pipe rail system of FIG. 8A.

FIG. 8C is a side view of a tubular telescoping or nested pipe rail system with a clamp, according to one implementation.

FIG. 8D is a side view of a tubular telescoping or nested pipe rail system with a clamp, according to another implementation.

FIG. 8E is a side view of the tubular telescoping or nested pipe rail system with a clamp of FIG. 8D.

FIG. 9 is a side view of a modular child/pet gate with locking mechanism details, according to another implementation.

FIG. 10 is a side view of a modular child/pet gate with locking mechanism details, according to another implementation.

FIG. 11 is a side view of a modular child/pet gate with locking mechanism details, according to another implementation.

### DETAILED DESCRIPTION

The present disclosure relates to a modular safety gate for use in various settings, such as homes, offices, or other environments where temporary barriers may be desired. The modular safety gate is designed to provide a secure and adjustable barrier while offering ease of installation and operation. In some cases, the modular safety gate may include multiple sections that can be configured to fit different openings or spaces. The gate may include a first side section and a second side section, with a gate door positioned between these side sections. This configuration allows for controlled access through the gate while maintaining a secure barrier when closed. The modular nature of the gate enables users to adapt the gate to various doorways, hallways, or other openings, potentially accommodating different widths and heights as needed.

Various implementations include a modular safety gate. The modular safety gate includes a first side section, a second side section, and a gate door positioned between the first side section and the second side section. The modular safety gate includes a locking mechanism attached to the gate door. The locking mechanism includes a grip attached to a vertical locking spindle and at least one pin extending from the grip. The at least one pin is configured to engage with corresponding cut-out portions in the first side section and the gate door to secure the gate door in a closed position.

Various other implementations include a modular safety gate. The modular safety gate includes a first side section, a second side section, and a gate door positioned between the first side section and the second side section. The modular safety gate includes at least one side arm attached to at least one of the first side section or the second side section. The at least one side arm includes a grip attached to the respective side section and at least two approximately parallel tines extending away from the respective side section. The tines are configured to squeeze a building structure therebetween.

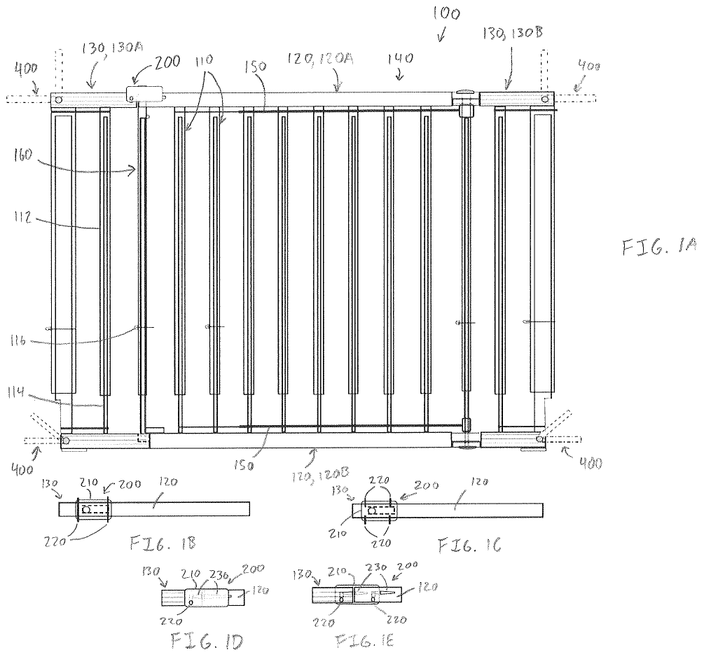

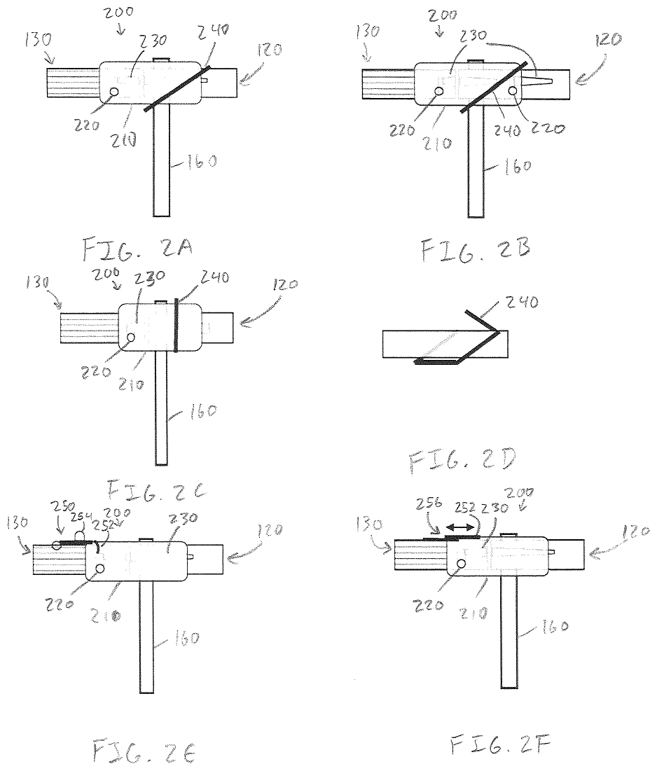

The modular safety gate 100 shown in FIG. 1A comprises a first side section 130A, a second side section 130B, and a gate door 140 positioned between the first and second side sections. As shown in FIG. 1A, the gate structure includes vertical spindles 110 connected by horizontal top 120A and bottom 120B rails (collectively referred to as rails 120), forming a barrier. The gate structures disclosed herein include various basic features that are included in the gate structure disclosed in U.S. Pat. No. 11,466,512, the entire disclosure of which is incorporated herein by reference.

The first 130A and second 130B side sections (collectively referred to as side sections 130) may be constructed from materials such as wood, metal, or rigid plastic. In some implementations, the rails 120 of the side sections include grooved out portions lined with plastic or metal inserts to enhance durability and facilitate smooth operation of moving components.

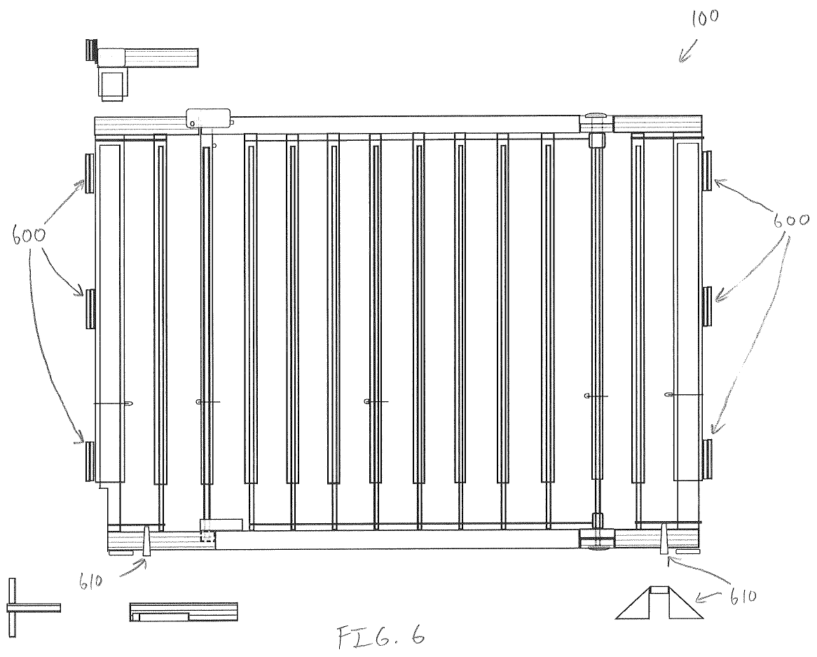

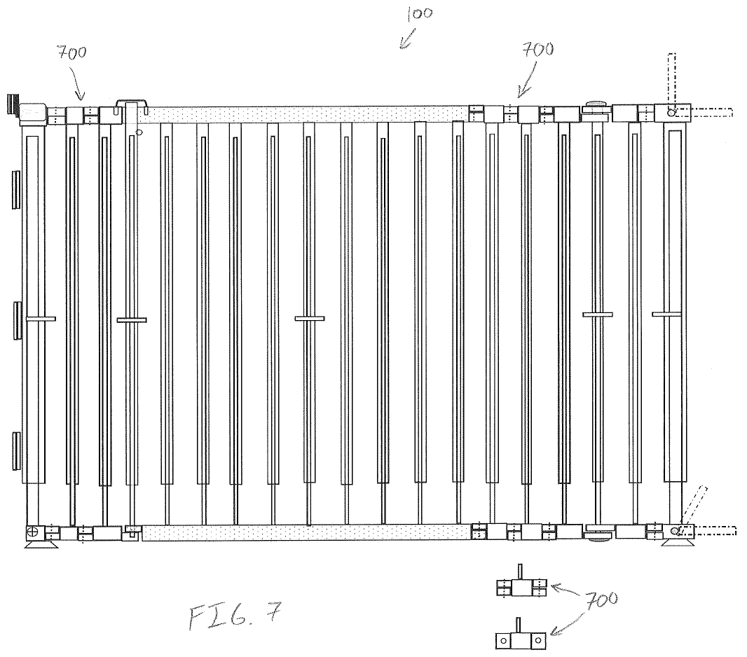

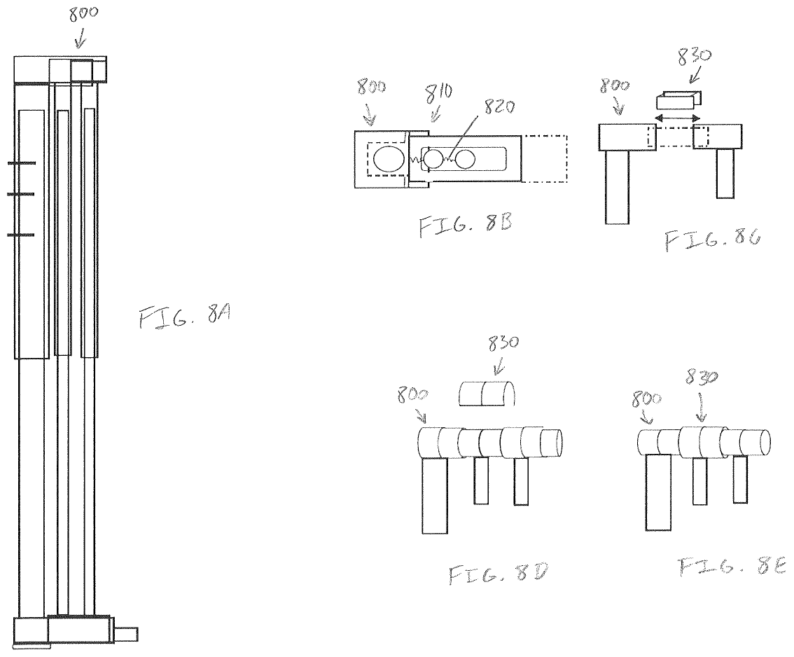

In some implementations, as depicted in FIG. 6, the gate 100 utilizes hook and loop attachments 600 for securing to walls or doorways. The hook and loop strips 600 may be attached to one side of the horizontal top rail 120A via a screw stud or adhesive snap male connector, providing a versatile mounting option for various surfaces.

For vertical height adjustment, the vertical spindles 110 can be telescoping and include an upper 112 and a lower 114 portion. One of the upper portion 112 or the lower portion 114 includes a central opening and the other of the second portion or the first portion is slidingly disposed within the central opening. A pin 116 may be placed in aligned openings of the upper portion 112 and the lower portion 114 of one vertical spindle 110 in each section of the gate to prevent the sliding of the upper portion relative to the lower portion to set the gate height. This feature allows for customization of the gate height to fit different openings.

Stabilizing bars 150 are permanently attached to the vertical spindles 110, positioned just below the top rail 120A and above the bottom rail 120B. These bars 150, as shown in FIG. 1A, provide additional structural support and assist with maintaining proper alignment during adjustments.

The gate door 140 is designed to operate smoothly within the frame created by the side sections 130A, 130B. In some cases, the door 140 may incorporate a locking mechanism 200 to secure it in a closed position. The overall design of the modular safety gate 100 allows for adaptability to various openings while maintaining a secure and stable barrier.

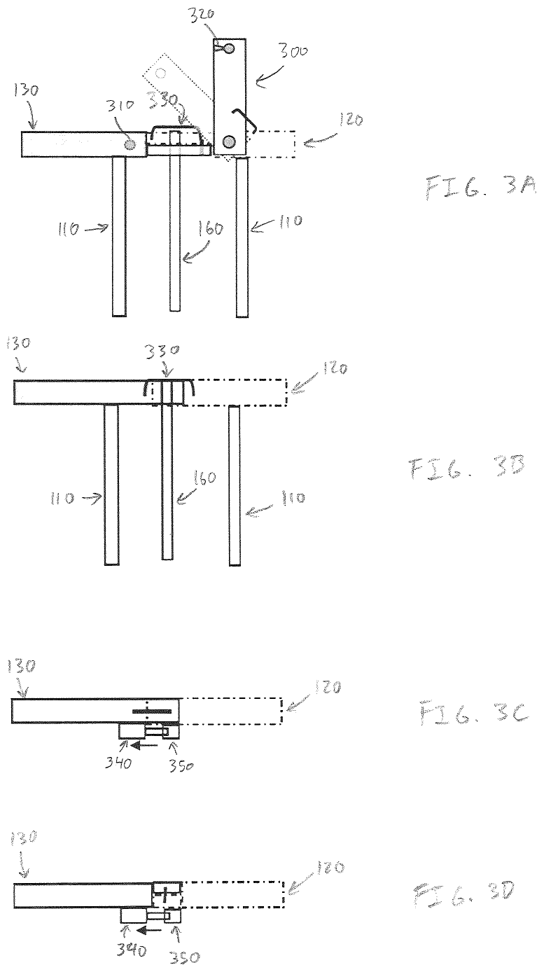

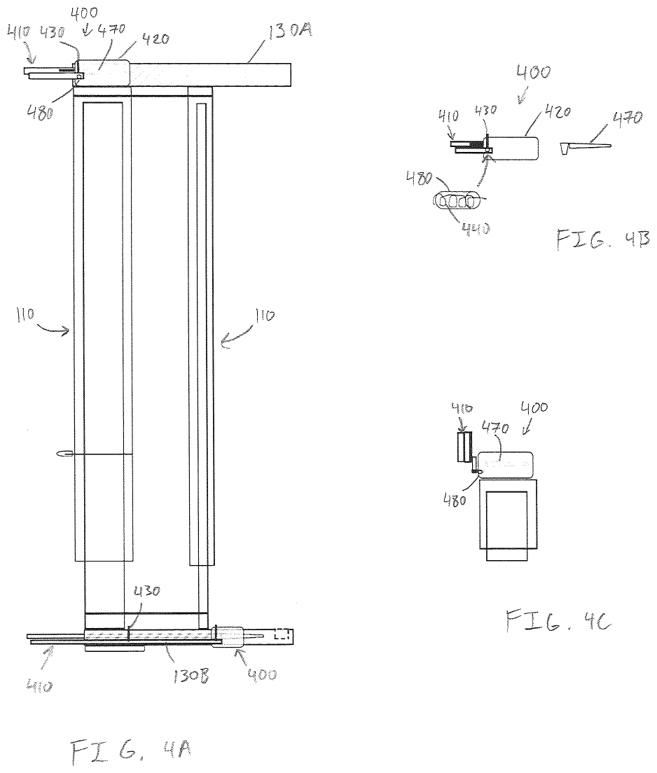

The safety gate 100 shown in FIG. 1A includes a locking mechanism 200 attached to the gate door 140. As shown in FIG. 1A-2F, the locking mechanism 200 comprises a saddle-shaped, or U-shaped, grip 210 attached to a vertical locking spindle 160 that has a lower portion that is slidingly engaged with a side section 130. The grip 210 is slightly oversized and may be constructed of wood, metal, hard rubber, or plastic.

The locking mechanism 200 further includes at least one pin 220 extending from the grip 210. FIGS. 1B-2F illustrate different configurations of the pin arrangement. For each variation shown in FIGS. 1B-2F, the at least one pin 220 of the locking mechanism 200 can comprise a single pin passing entirely through the grip 210, as shown in FIG. 1B. In another configuration, the one or more pins 220 of the locking mechanism 200 can comprise two pins extending from opposing sides of the grip 210, as shown in FIG. 1C. These two pins are aligned with each other but are axially spaced apart. In some implementations, the grip 210 can include a first pin that engages the side portion 130 in the locked configuration and a second pin that engages the gate door 140 in the locked configuration. In some implementations, the locking mechanism 200 comprises four pins 220 total, with two pairs of aligned but axially spaced apart pins. This configuration provides additional stability and security to the locking mechanism 200.

As shown in FIGS. 1A-2F, the pin or pins 220 are configured to slidingly engage with corresponding grooves 230 in the first side section 130A and the gate door 140 to secure the gate door in a closed position. As depicted in FIGS. 1A-2F, these grooves 230 may comprise tapered grooves in the first side section 130A and the gate door 140. The tapered design facilitates smooth engagement and disengagement of the pins 220.

FIGS. 1A-1E show how the grip 210 slides upwards and back along the cut-out portions of opposing top rails 120A to enable bi-directional gate opening when the grip 210 exits the stationary rail completely. This movement allows the vertical locking spindle 160 to disengage from its seated position in the bottom rail 120B, clearing the gap between the gate door 140 and the side section 130.

In some implementations, the grooves 230 and/or the pins 220 can include plastic or metal, such as inserts, that can enhance pin movement and durability.

In use, the grip 210 of the locking mechanism 200 is lifted such that the pin 220 engaging the groove 230 in the side section 130 is raised upwardly within the groove. In implementations that include one or more pins 220 that engage the groove 230 in the gate door 140, the lifting of the grip 210 moves these one or more pins upwardly in those grooves as well. The lifting of the grip 210, which is attached to the vertical locking spindle 160, causes the vertical locking spindle 160 to be lifted, which causes the lower end of the vertical locking spindle 160 to disengage with the side section 130 and allows the vertical locking spindle 160 to slide with the grip 210. The grip 210 is then slid horizontally such that the pins 220 slide through the grooves 230 in the side section 130 and into the groove 230 in the gate door 140. In this position, the grip 210 is entirely disengaged with the side section 130. Because the grip 210 and the vertical locking spindle 160 are disengaged from the side section 130, the gate door 140 is able to pivot relative to the side sections 130. To re-lock the gate door 140 in the closed position, the above actions can be performed in reverse to cause the grip 210 to reengage with the side section 130 and to cause the lower portion of the vertical locking spindle 160 to reengage with the side section 130.

The modular safety gate 100 incorporates various redundant locking mechanisms to enhance security and prevent unintended opening by children or pets. As shown in FIGS. 2A-2D, one such mechanism comprises a strap 240 attached to the gate door 140. The strap 240 may be made of hook and loop material, leather, rubber, or other suitable materials. In some implementations, the strap 240 includes a female snap at one end that corresponds to a male screw stud snap fastened to one side of the gate door's top rail 120A. When engaged, the strap 240 wraps around the grip 210 and the locking spindle 160, providing an additional layer of security.

FIG. 2E illustrates a redundant swivel lock 250 attached to the upper surface or recessed within the upper rail 120A of the side section 130. To engage this lock 250, the user swivels it toward the locking grip 210 while the gate is closed. The lock 250 snaps into a receptacle 252 in the top or recessed surface of the locking grip 210, similar to a screen door lock. To disengage, the user grasps a rounded fin or ring 254 on the lock 250 (or any other portion), pulls up, and swivels it towards the side section 130.

An alternative redundant locking mechanism, depicted in FIG. 2F, comprises a slide latch 260 mounted on or recessed within the top rail 120A surface of the side section 130. When the gate door 140 is closed, the slide latch 260 engages with a partner receptacle in the opposing upper end of the locking grip 210. To unlock, the user simply slides the latch 260 toward the side section 130.

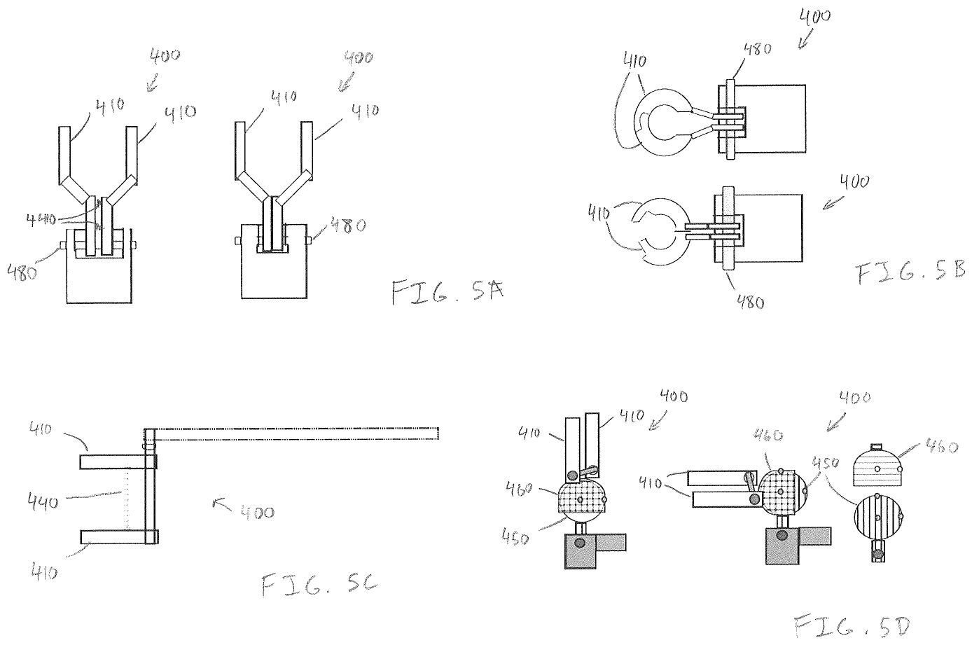

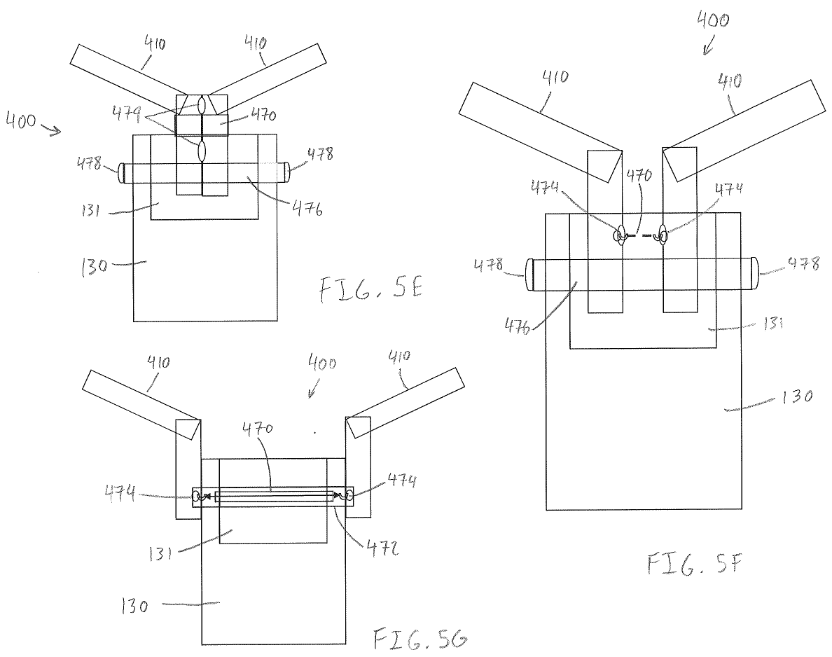

FIG. 3A showcases another redundant locking mechanism in the form of a 3-sided cover 300. This cover 300 may be attached to either the gate door 140 top frame or the side section 130 top frame via a bolt or pin. The attachment allows the cover 300 to be swiveled upward, for example by at least a 90-degree angle, and in some cases, up to 135 degrees. The swiveling end of the cover 300 can feature a cut-out portion to facilitate this movement.

The cover 300 incorporates a spring plunger 310 positioned in the side of the top frame. To release the cover 300, the user must push this plunger 310. A receiving hole for the spring plunger 310 is located on the outer side of the cover 300. In some implementations, a shallow, sloped canal 320 is incorporated on the inside surface of the cover 300. This canal 320 provides a continuous path to the receiving hole, allowing the cover 300 to be pushed down into a locked position without the need to press the spring plunger 310.

The 3-sided cover 300 is disposed over a T-handle 330 or other type of handle at an upper portion of the vertical locking spindle 160. Once the cover 300 is rotated to expose the handle 330 of the vertical locking spindle 160, the handle 330 can be grasped and the vertical locking spindle 160 can be lifted to disengage the lower portion of the vertical locking spindle 160 from the side section 130 to allow the gate door 140 to swing freely.

In some cases, the redundant locking mechanisms may be designed for use with single-or double-direction gate doors, as well as split double gate doors. The specific configuration may vary depending on the overall gate design and intended use.

FIGS. 3C-3D show implementations of the gate door 140 and side section 130 that includes a sliding latch 340 for redundant locking. The sliding latch 340 can be coupled to one of the gate door 140 or the side section 130 and can be actuated to disengage a receptacle 350 on the other of the side section 130 or the gate door 140. As shown in the top view of FIG. 3C, a portion of the gate door 140 can vertically overlap a portion of the side section 130 such that one portion is above the other portion. FIG. 3D shows an alternate configuration in which a portion of the gate door 140 horizontally overlaps a portion of the side section 130 such that one portion is beside the other portion.

These redundant locking mechanisms work in conjunction with the primary locking mechanism 200 to provide enhanced security. By incorporating multiple layers of protection, the modular safety gate 100 offers increased resistance to unintended opening, thereby improving overall safety for children and pets.

As shown in FIGS. 4A-5D, the modular safety gate 100 can incorporate various side arm 400 options to accommodate different mounting scenarios and provide secure attachment to doorways or other structures. FIGS. 4A-5D illustrate several side arm 400 configurations designed to enhance the versatility and stability of the gate 100.

As shown in FIGS. 4A-5A, one side arm 400 option comprises at least two approximately parallel tines 410 extending away from the respective side section 130. These tines 410 are configured to squeeze a building structure between them, providing a secure grip. The tines 410 may be flexible and include non-marring surfaces to prevent damage to the mounting surface.

The side arms 400 include a grip 420 that slidingly engages the upper rail 120A in a configuration such as those described elsewhere herein. This grip-assisted retractable side arm 400 configuration allows the grip 420 to attach to the respective side section 130 and includes a sliding mechanism configured to retract and extend the tines 410. In some implementations, this sliding mechanism comprises a pin 480 that engages with a track 470 in the respective side section 130, allowing for smooth and controlled movement of the side arm 400.

To enhance stability and prevent unintended movement, FIGS. 4A and 4B show a U-shaped bar 430 with outward extensions affixed to the tines 410. This bar 430 helps prevent downward drift of the side arm 400 when installed. In some cases, the U-shaped bar 430 may be placed over an outer end of the grip 420 for additional support.

The side arm 400 includes flexible metal arms as a side arm option, as seen in FIG. 5A. As shown in FIGS. 4B and 5A, in some implementations, these tines 410 may include a spring 440 to allow separation of the tines 410 when fitting around a building structure. This feature enables the side arm 400 to accommodate various doorway thicknesses while maintaining a secure grip. As shown in FIG. 4B, the pin 480 of the side arm mechanism 400 can be hollow, and the spring 440 can be disposed within the hollow portion of the pin 480.

FIG. 5B showcases a ring collar clamp side arm 400 option. This mechanism may include a spring-loaded opening mechanism, allowing for easy attachment and removal while providing a secure grip when engaged.

An off-set arm configuration is depicted in FIG. 5C, where the side arm 400 is offset from the respective side section 130. This design allows for placement of the gate 100 slightly forward in a doorway, providing additional flexibility in installation.

In some implementations, the side arm 400 may comprise a ball 450 and joint 460 connection to the respective side section 130, as illustrated in FIG. 5D. This configuration allows for flexible positioning of the side arm 400, enabling adaptation to various mounting surfaces and angles.

FIGS. 5E-5G illustrate additional side arm 400 configurations. As shown in FIGS. 5E-5G, the side arm 400 may include a stretchy cord, strap, or expansion spring 470 encased in nested tubes 472 and attached to a lower side portion of the tines 410. In some implementations, the stretchy cord, strap, or expansion spring 470 is attached to the tines 410 via screw hooks 474 with hooks facing inward. This configuration allows the tines 410 to be stretched apart to fit around a door frame while the stretchy cord, strap, or expansion spring 470 provides tension to maintain a secure grip on the building structure.

As shown in FIG. 5E, the tines 410 may include optional finger indents 479 on a grip surface to facilitate grasping and operation. The side arm 400 may also include a tube or barrel screw component 476 with a cap 478 at an end thereof. The respective side section 130 may include a cutout recessed portion 131 configured to allow expansion of the side arm 400, enabling the tines 410 to extend outward when needed and retract into the respective side section 130 via the cutout recessed portion 131 when not in use. In some implementations, the hooks 474 may be screwed into lower portions of the tines 410, with the hooks 474 configured to be placed at finger openings to allow easy opening of the side arm 400.

FIG. 4A demonstrates how at least one side arm 400 may be attached to at least one of the first side section 130A or the second side section 130B of the modular safety gate 100. This figure shows the integration of the side arm 400 with the overall gate structure, illustrating how it contributes to the stability and secure mounting of the gate 100 in a doorway or opening.

These various side arm 400 options provide users with multiple choices for securing the modular safety gate 100 in different environments. The flexibility and adaptability of these designs enable the gate 100 to be installed securely in a wide range of doorways, hallways, or other openings, enhancing its versatility and effectiveness as a safety barrier.

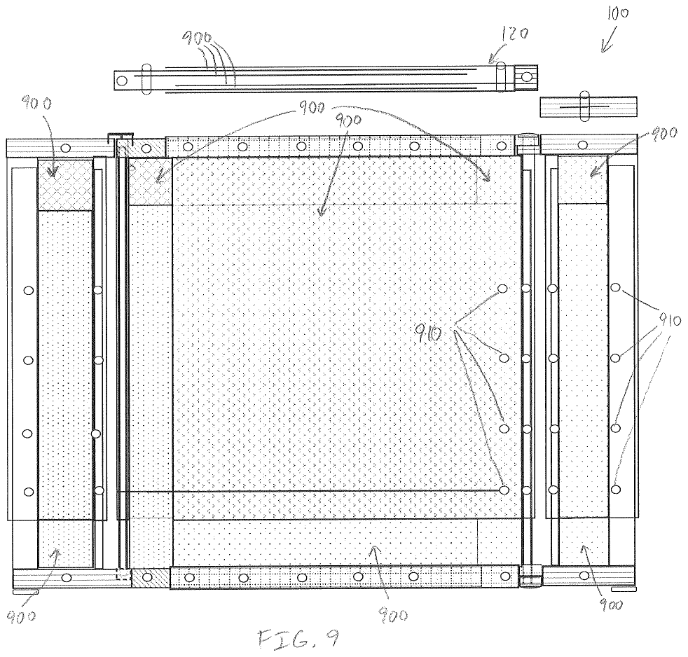

The modular safety gate 100 incorporates various adjustment mechanisms to accommodate different opening sizes and configurations. FIG. 7 illustrates an individual spindle adjustment feature that allows for incremental horizontal adjustment. This mechanism utilizes a modular 2-member vertical spindle section 700 with fixed rail components that can be connected to existing side sections 130 or gate door 140 sections. The modular spindle sections 700 can be configured to engage adjacent modular sections with a vertical overlap or a horizontal overlap, with fasteners securing the adjoining rails. In some implementations, the modular spindle sections 700 can include any number of vertical spindles 110 and any number of modular spindle sections 700 can be combined to side sections 130 or the gate door 140 to create a gate of any horizontal size.

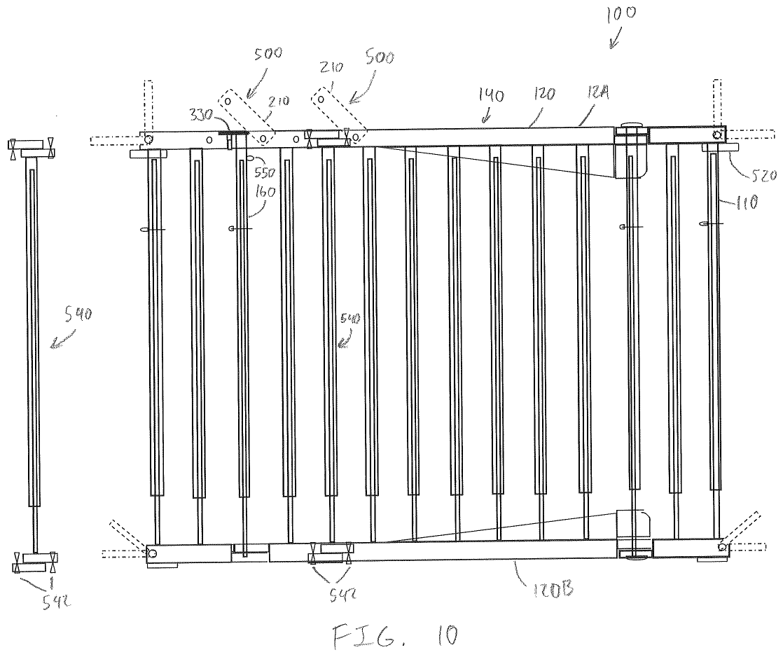

FIGS. 8A-8E demonstrate a tubular telescoping or nested pipe rail system 800 for horizontal adjustment. This feature can be implemented in any section of the gate 100, including side sections 130, gate doors 140, and expansion units. The tubular telescoping or nested pipes 800 can be extended to a predetermined width, allowing for customization to fit various openings. In some implementations, accordion hinges 810 or cord limiters 820 may be used to control the extension of these components, as shown in FIG. 8B. As shown in FIGS. 8C-8E, clamps 830 can be snapped into place to hold the affected vertical spindle 110 position once the desired width is achieved.

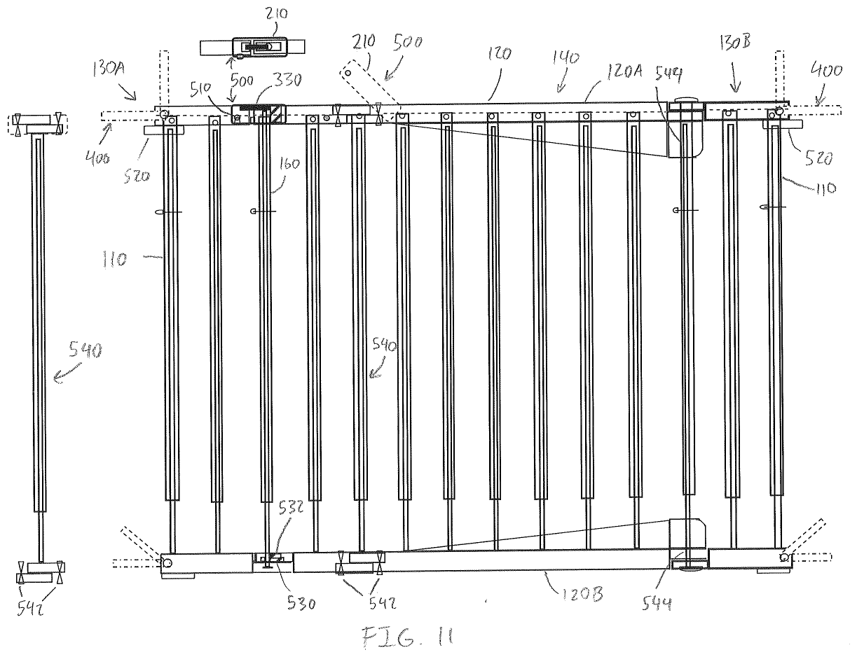

FIG. 9 showcases a combination of solid panels 900 that allow for both horizontal and vertical adjustment. The gate structure incorporates upper 120A and lower 120B rails that are 2-part, 3-sided nested sections for length adjustment. The outer rail section can slide over the inner rail section to achieve the desired width within permissible limits. These rails feature holes or fasteners 910 along their side surfaces that correspond to holes or fasteners 910 in the panels 900, allowing for secure fastening at various width intervals. The solid panels 900 are arranged in an overlapping configuration within the frame, with upper panels overlapping lower panels to prevent gaps.

For the gate 100 shown in FIG. 9, the panels 900 of the modular safety gate 100 may be releasably coupled to opposing horizontal rails 120 or to opposing vertical supports 110 using the above mentioned holes and fasteners 910. A first panel may be coupled to the vertical supports 110 and positioned adjacent to a top horizontal rail 120A, while a second panel may be coupled to the vertical supports 110 and positioned adjacent to a bottom horizontal rail 120B. A third panel may be coupled to the horizontal rails 120 and positioned adjacent to a first vertical support 110, and a fourth panel may be coupled to the horizontal rails 120 and positioned adjacent to a second vertical support 110. All four of the panels 900 overlap in this way.

When adjustments to the vertical supports 110 or horizontal rails 120 are needed, the panels 900 may be uncoupled from one vertical support 110 or horizontal rail 120, respectively, to allow for adjustment. The panels 900 may include two or more rows of adjustment holes or fasteners 910 that releasably couple to the holes or fasteners 910 of the vertical supports 110 or horizontal rails 120. After the vertical supports 110 or horizontal rails 120 are adjusted, the panels 900 may be recoupled to the vertical support 110 or horizontal rail 120 using a different row of adjustment holes or fasteners 910, allowing for flexible configuration of the gate's dimensions.

In some implementations, the solid panel 900 configuration may include permanently secured panels at the outer corners, with other points in the horizontal rails 120 and vertical spindles 110 available for width and height adjustment. The lower rail 120B may incorporate centrally placed panels 900 to ensure they are encased by the upper panels on at least one side of the gate 100. Upper panels may be positioned towards the exterior surfaces of the upper rail 120A to encase the lower panels, providing a secure and gap-free barrier.

The side sections 130 can include similar panels 900 with holes or fasteners 910. In some implementations, the side panels only include vertical height adjustment and only include two panels (i.e., a top panel adjacent the top rail 120A and a bottom pane adjacent the bottom rail 120B).

The adjustment mechanisms described allow for customization of the modular safety gate 100 to fit a wide range of openings. By incorporating both horizontal and vertical adjustment features, the gate 100 can be adapted to various doorways, hallways, or other spaces while maintaining a secure and stable barrier. The solid panels 900 prevent objects from passing through openings in the gate 100.

The modular safety gates 100 disclosed herein comprise multiple components that work together to create a secure and adjustable barrier. The gate structures shown in FIGS. 1A-8E include vertical spindles 110 connected by horizontal top 120A and bottom 120B rails, forming a cohesive unit. The gate door 140 is positioned between two side sections 130, allowing for controlled access through the barrier.

The locking mechanism 200, attached to the gate door 140, interacts with the side sections 130 to secure the gate in a closed position. The grip 210, connected to a vertical locking spindle 160, engages with cut-out portions in the side section 130 and gate door 140. This interaction ensures a tight closure and prevents unintended opening of the gate 100.

Stabilizing bars 150, positioned just below the top rail 120A and above the bottom rail 120B, provide additional structural support to the vertical spindles 110. These bars 150 contribute to the overall stability of the gate 100 and assist in maintaining proper alignment during adjustments.

FIG. 6 illustrates on implementation for how the gate 100 can be secured to walls or doorways using hook and loop attachments 600. This mounting system interacts with the side sections 130 of the gate 100, providing a versatile installation option for various surfaces. The hook and loop strips 600 attach to the horizontal top rail 120A, creating a secure connection between the gate 100 and the mounting surface. FIG. 6 also shows that the bottom horizontal rail 120B can include one or more feet 610 to help stabilize the gate 100.

In some implementations, the gate 100 includes side arms 400 that interact with the building structure to provide additional stability. These side arms 400 may incorporate flexible tines 410 or grips 420 that squeeze the building structure, ensuring a secure fit in different doorways or openings.

FIGS. 10 and 11 illustrate implementations of the modular safety gate 100 that include a saddle cover 500 fastened to the grip 210. The saddle cover 500 is configured to lift and slide with the grip 210 to open the gate door 140. In some implementations, the saddle cover 500 includes a spring pin mechanism 510 for securing the saddle cover 500 in a closed position. The saddle lock cover 500 may be particularly useful when no expansion spindle is in place. The grip 210 may comprise a T-handle 330 attached to the saddle cover 500 and connected to the vertical locking spindle 160. A fastener allowing rotation may be used to operate the saddle cover 500. In use, the saddle cover 500 can be lifted from one end using a screw or spring pin as an opening mechanism. Barrel screws or similar fasteners may connect each upper and outer spindle through the railing to provide secure vertical lifting.

As shown in FIGS. 10 and 11, the modular safety gate 100 may include a spindle encasement piece 520 attached to an underside of a rail 120 of the first side section 130A or the second side section 130B. The spindle encasement piece 520 encases a vertical spindle 110 and extends outwardly from the rail 120 on each side to serve as a downward limiter for at least one side arm 400 that attaches to the outside of the rail 120. In some implementations, the spindle encasement piece 520 extends from the rail 120 by one to two inches on each side. This configuration helps prevent the side arms 400 from drifting downward during use.

As depicted in FIG. 11, a bottom rail 120B of the first side section 130A may include a lower cutout 530 and an upper cutout 532. The lower cutout 530 is wider and lower in height than the upper cutout 532. The upper cutout 532 is offset to one side to prevent the vertical locking spindle 160 from being pulled out while remaining wide enough to allow the vertical locking spindle 160 to slide horizontally to open the gate door 140. This lock mechanism configuration, in conjunction with the upper offset cutout 532, limits the height of lift for the vertical locking spindle 160.

As shown in FIGS. 10 and 11, the modular safety gate 100 may include a single spindle expansion unit 540 configured to extend a width of the gate door 140. The single spindle expansion unit 540 includes insert slots 542 for bolts or barrel screws. In some implementations, the single spindle expansion unit 540 includes flat head bolts, rounded head bolts, or any other kind of fastener configured to extend the width of the gate 100 one section at a time as needed. This modular approach allows users to incrementally adjust the gate width to fit various openings.

As shown in FIG. 10, the top rail 120A and the bottom rail 120B may each include holes 544 configured to allow vertical spindles 110 to pass through and attach to the rails 120. This configuration serves to stabilize the gate door 140 and prevent sagging. The top and bottom rails 120 may be expanded below or above as one piece up to the point of horizontal expansion.

In some implementations, the upper and lower sections of a two-part rail are glued together in addition to being bolted. The lower inside spindles, except for the lifting spindle, may be glued or fastened to secure them to the bottom frame. This combination of gluing and fastening provides enhanced structural integrity to the gate 100.

As shown in FIG. 10, the modular safety gate 100 may include a limiter 550 to prevent the lifting spindle from pulling out of the bottom rail 120B. This limiter 550 works in conjunction with the cutout configuration to ensure the vertical locking spindle 160 remains properly engaged with the gate structure during operation.

The redundant locking mechanisms work in conjunction with the primary locking mechanism 200 to enhance security. These additional locks may include straps 240, swivel locks 250, or slide latches 260 that engage with various parts of the gate structure, providing multiple layers of protection against unintended opening.

In some cases, the gate 100 may include a wraparound band that threads through small openings near the edges of the panels 900. This band interacts with the panels 900 and frame to keep the panels securely in place, reducing the risk of dislodgement by children or pets.

The overall interaction of these components results in a modular safety gate 100 that adapts to various environments while maintaining a secure and stable barrier. The adjustability features, combined with the locking mechanisms and mounting options, allow users to customize the gate 100 to their specific needs while ensuring consistent functionality and safety.

A number of example implementations are provided herein. However, it is understood that various modifications can be made without departing from the spirit and scope of the disclosure herein. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

Disclosed are materials, systems, devices, methods, compositions, and components that can be used for, can be used in conjunction with, can be used in preparation for, or are products of the disclosed methods, systems, and devices. These and other components are disclosed herein, and it is understood that when combinations, subsets, interactions, groups, etc. of these components are disclosed that while specific reference of each various individual and collective combinations and permutations of these components may not be explicitly disclosed, each is specifically contemplated and described herein. For example, if a device is disclosed and discussed each and every combination and permutation of the device are disclosed herein, and the modifications that are possible are specifically contemplated unless specifically indicated to the contrary. Likewise, any subset or combination of these is also specifically contemplated and disclosed. This concept applies to all aspects of this disclosure including, but not limited to, steps in methods using the disclosed systems or devices. Thus, if there are a variety of additional steps that can be performed, it is understood that each of these additional steps can be performed with any specific method steps or combination of method steps of the disclosed methods, and that each such combination or subset of combinations is specifically contemplated and should be considered disclosed.

1. A modular safety gate, comprising:
a first side section;
a second side section;
a gate door positioned between the first side section and the second side section;
a locking mechanism attached to the gate door, the locking mechanism comprising:
a grip attached to a vertical locking spindle; and
at least one pin extending from the grip, wherein the at least one pin is configured to engage with corresponding cut-out portions in the first side section and the gate door to secure the gate door in a closed position.

2. The modular safety gate of claim 1, wherein the cut-out portions comprise tapered grooves in the first side section and the gate door.

3. The modular safety gate of claim 1, wherein the locking mechanism comprises two pins extending from the grip.

4. The modular safety gate of claim 3, wherein the two pins are aligned with each other but axially spaced apart.

5. The modular safety gate of claim 4, wherein the locking mechanism comprises four pins total, with two pairs of aligned but axially spaced apart pins.

6. The modular safety gate of claim 1, wherein the at least one pin comprises a single pin passing entirely through the grip.

7. The modular safety gate of claim 1, wherein the locking mechanism further comprises a swivel lock pivotably coupled to the first side section and configured to engage with the grip when the gate door is in the closed position.

8. The modular safety gate of claim 1, further comprising a redundant locking mechanism comprising a strap attached to the gate door and configured to wrap around the grip when the gate door is in the closed position.

9. The modular safety gate of claim 1, further comprising a redundant locking mechanism comprising a slide latch mounted on the first side section and configured to engage with the gate door when in the closed position.

10. The modular safety gate of claim 1, further comprising a redundant locking mechanism comprising a swivel cover attached to the gate door and configured to cover the grip when the gate door is in the closed position.

11. The modular safety gate of claim 1, further comprising a saddle cover fastened to the grip, wherein the saddle cover is configured to lift and slide with the grip to open the gate door.

12. The modular safety gate of claim 11, wherein the saddle cover includes a spring pin mechanism for securing the saddle cover in a closed position.

13. The modular safety gate of claim 11, wherein the grip comprises a T-handle attached to the saddle cover and connected to the vertical locking spindle.

14. The modular safety gate of claim 1, further comprising a spindle encasement piece attached to an underside of a rail of the first side section, the spindle encasement piece extending outwardly from the rail on each side to serve as a downward limiter for at least one side arm.

15. The modular safety gate of claim 14, wherein the spindle encasement piece extends from the rail by one to two inches on each side.

16. The modular safety gate of claim 1, wherein a bottom rail of the first side section includes a lower cutout and an upper cutout, the lower cutout being wider and lower in height than the upper cutout, and the upper cutout being offset to one side to prevent the vertical locking spindle from being pulled out while allowing the vertical locking spindle to slide horizontally to open the gate door.

17. The modular safety gate of claim 1, further comprising a single spindle expansion unit configured to extend a width of the gate door, the single spindle expansion unit including insert slots for bolts or barrel screws.

18. The modular safety gate of claim 1, wherein a top rail and a bottom rail each include holes configured to allow vertical spindles to pass through and attach to the rails to stabilize the gate door and prevent sagging.

19-37. (canceled)
